(19) United States
(12) Patent Application Publication
(10) Pub. No.: US 2002/0191247 A1
(43) Pub. Date: Dec. 19, 2002

(54) Fast restoration in optical mesh network

(76) Inventors: Xiang Lu, Bishops Stortford (GB); Song Dong, Egham (GB)

Correspondence Address: William M. Lee, Jr., Lee, Mann, Smith, McWilliams, Sweeney & Ohlson, P.O. Box 2786, Chicago, IL, 60690-2786, US

(21) Appl. No.: 09/846,096

(22) Filed: Apr. 30, 2001

(51) Int. Cl. H04B 10/08; H04J 14/02

(52) U.S. Cl. 359/124; 359/110

(57) ABSTRACT

A wavelength division multiplexed optical network has a restoration process to re-route one or more of the wavelengths, by dynamically determining possible restoration routes, and re-routing each wavelength along a chosen one of the possible restoration routes. A distributed dynamic search for restoration routes down to the optical layer, for wavelengths, gives faster and more scalable restoration than reconfiguring routing tables and enables much better utilisation of bandwidth than using predetermined restoration paths.

### FIELD OF THE INVENTION

The invention relates to wavelength division multiplexed optical networks, to nodes for such networks, to restoration processes for such networks, to software for carrying out such processes, to signals sent when carrying out such processes, and to methods of transmitting data traffic over such networks arranged to carry out such restoration processes.

### BACKGROUND TO THE INVENTION

Restoration is a growing area of concern in high bandwidth optical networks. Restoration involves re-routing a data signal onto a spare path. Fibre cuts, and hardware/equipment failures are the main reasons why networks typically have some redundant capacity and a restoration scheme to make use of it. It is possible to provide for re-routing the data traffic at various levels in the well-known 7 layer OSI model. For example, at layer 3, IP Packets may be re-sent, at layer 2/3, ATM (asynchronous transfer mode) circuits may be restored on to different routes, and ATM cells may be buffered. At layer 1, the SONET (Synchronous Optical Network) standard provides for path restoration, or line restoration. Line restoration involves re-routing traffic carried between line terminating equipment at each end of a single link, to an alternative route to avoid the failed link. Path restoration involves allocating an alternative path between source and destination nodes, thus may involve many different links.

Generally, the lower layer restoration techniques tend to be faster, and therefore less data will be lost during the outage. This is becoming more important as data capacity of individual links increases rapidly. SONET networks may be point to point, ring, or mesh architectures. In principle, restoration routes can be pre-planned or dynamically determined. The remainder of this document is concerned with dynamically determined routes.

Furthermore, in principle, determining restoration routes can be carried out centrally, or in distributed fashion, by the nodes themselves. In practice, advanced centralised techniques tend to generate large amounts of overhead message traffic, much of it from alarms generated as a consequence of the first fault. This traffic may congest the control data communication channels. Hence the restoration may be delayed, partly by the time needed for alarm correlation, to locate the fault or faults. It is known from “the self- healing network” by Grover, to use a dynamic distributed technique for determining restoration routes in a mesh network using digital cross-connects and SONET signalling protocols. It involves the node downstream of a failure detecting the failure and broadcasting a message to all its neighbouring nodes, which in turn re-broadcast to their neighbouring nodes. Some of these messages will arrive at nodes on the original path upstream of the fault. If such messages record the identities of the nodes they have passed through, this identifies a suitable restoration path. The shortest path with sufficient capacity can then be chosen.

While rings usually require 100% redundancy for full protection, the great advantage of mesh networks is that they require much less redundancy for a similar level of protection.

When carrying out restoration at the SONET level, it is necessary to access the SONET overhead data, which involves providing expensive receiver equipment, to convert an optical transmission signal to the electrical domain, for decoding. More recently, it has been proposed to switch optical signals without conversion to the electrical domain. Many optical signals at different wavelengths can be switched individually, then wavelength division multiplexed for transmission to other nodes. Such networks are called wavelength-routed networks. In such networks, a separate control network is provided to enable messages to be passed between nodes to control the routing of individual wavelengths. Various possibilities for protection or restoration at the optical layer have been proposed. Firstly, protection paths may be predetermined, which can be applied to point to point topologies, ring topologies and mesh topologies. Secondly, for mesh topologies, it has been proposed to dynamically reconfigure the mesh, and rebuild all routing tables in the nodes from scratch, using routing protocols such as OSPF (Open Shortest Path First).

The main disadvantage of the first of these options, the predetermined protection paths, is that it requires 100% redundancy, since any sharing of predetermined protection paths leaves a risk that two simultaneous faults could not be restored. Nevertheless, this is often favoured because it enables fast (less than 50 millisecond) and reliable restoration, which will minimise the amount of data lost.

The second option, of reconfiguring the mesh network, enables better utilisation of bandwidth, but is much slower, depending on the protocols used, and the complexity of the mesh. It is less scalable. The speed of restoration gets worse for more complex meshes.

Recent advances in dense wavelength-division multiplexing (DWDM) and optical cross-connects will enable the transition from point-to-point transmission to wavelength routed mesh optical networks. These new developments in network connectivity will enable network operators to offer new dynamic service offering end-to-end connections over wide-area distance and independent of the line rate of the network. The dynamic provisioning of light paths in wavelength routed optical networks requires a control plane for the establishment and maintenance of optical wavelength channels.

Proposed extensions of the current IP protocols, Multi-Protocol Label Switching (MPLS) to the circuit based optical and photonic networks include applying IP based, distributed routing and signaling mechanism to the control of the optical and photonic layer. For any provisioned circuit in a mesh network, possible protection and restoration methods include:

A) rerouting of the circuit after the topology of the network reconverges; and

B) pre-provisioned 1+1 protection.

The drawback of the rerouting possibility is mainly the time it requires to detect the failure, with the conventional routing protocol such as OSPF (Open Shortest Path First) it would take 4 times the ‘Hello’ interval (10 seconds by default) for the for OSPF neighbors to notice the loss of adjacency and for the routing table to start to re-converge, even with fast detection of the failure, the convergence time of the routing table could take in the scale of seconds to tens of seconds, depending on the complexity of the mesh network

One disadvantage of the above mentioned pre-provisioned 1+1 protection possibility is the requirement to reserve protection bandwidth from ingress node to egress node, thus decreasing the utilization of the network.

In some literature, the term “protection” implies a physical layer process, and the term “restoration” implies higher layer processes. In this document, the term restoration is intended to encompass both.

### SUMMARY OF THE INVENTION

It is an object of the invention to provide a fast scalable distributed restoration scheme at the optical layer.

According to a first aspect of the invention there is provided a wavelength division multiplexed optical network having nodes coupled by links, to enable wavelengths to be routed across the network, the nodes being arranged to carry out a restoration process to re-route one or more of the wavelengths, the restoration process having the steps of:

sending messages between the nodes to dynamically determine possible restoration routes, and

re-routing each wavelength along a chosen one of the possible restoration routes.

An advantage of such a distributed dynamic search for restoration routes for wavelengths, is that restoration can be faster than previous methods of reconfiguring all the parts of the mesh affected by the fault. Furthermore, compared to the above mentioned use of predetermined restoration paths, the dynamic search for restoration routes enables much better utilisation of bandwidth. Also, notably, the speed of restoration can be maintained even as the complexity of the mesh increases.

A notable feature of some of the embodiments of the invention is that the choice of restoration route from the possible restoration routes, is made on the basis of optical parameters of the restoration route, and of the remainder of the path for the given wavelength.

Another feature of some of the embodiments is the provision of the capability to switch traffic from one wavelength to a different wavelength, and choose not only the restoration route, but also choose a wavelength within that route.

Another preferred feature of some of the embodiments involves having a node local to the fault make the choice of which of the possible restoration paths to choose. Such local processing enables faster operation and greater scalability.

Another preferred feature of some of the embodiments involves reserving bandwidth on the restoration routes only after the choice from the possible restoration paths, has been made.

Another preferred feature involves making a separate search for possible restoration paths, for each wavelength or bands of wavelengths, to be restored.

Another preferred feature involves sending messages along the chosen restoration path to reserve the bandwidth, and if there is insufficient bandwidth, choosing another of the possible restoration routes.

Another preferred feature of some of the embodiments involves choosing a restoration path which rejoins the original path at a node not adjacent to the fault.

Another aspect of the invention provides a node for carrying out the steps set out above. Another aspect of the invention provides a node for carrying out the steps set out above and arranged to carry out the functions of Sender, or Chooser or tandem. Another aspect of the invention provides software for use at a node for carrying out the steps set out above. Another aspect of the invention provides a sequence of data signals on a link, following the steps set out above. Another aspect provides a method of transmitting data over a network arranged to carry out the steps set out above.

Any of the optional features may be combined with any of the aspects of the invention as appropriate, as would be apparent to those skilled in the art. Other advantages to those indicated above may be apparent to those skilled in the art, particularly relative to other prior art not known to the inventors.

### BRIEF DESCRIPTION OF THE DRAWINGS

In order to show how the invention can be carried into effect, embodiments of the invention are now described below by way of example only, and with reference to accompanying figures in which:

FIG. 1A shows a prior art proposal for parts of a wavelength routed optical network,

FIG. 1B shows in schematic form a prior art arrangement of a wavelength routed optical network, having a control plane and a transport plane,

FIG. 2 shows in schematic form a prior art node for use in the network of FIG. 1A or 1B,

FIG. 3 shows principal steps carried out by software in nodes such as those shown in FIG. 2, according to an embodiment of the invention,

FIG. 4 shows steps according to a further embodiment of the invention,

FIG. 5 shows an arrangement of nodes and links, including a faulty link, and showing which nodes take the roles of Sender, Chooser, and Selector candidate, during the restoration process,

FIG. 6 shows a table of wavelengths and optical characteristics for each of a number of alternative routes around the fault shown in FIG. 5,

FIG. 7 shows a sequence chart indicating some of the principle actions carried out by the Selector candidate, Chooser, tandem and Sender nodes shown in FIG. 5, during the restoration process,

FIG. 8 shows a flow chart with more details of what any node does when it receives a PSA message as part of the process of identifying alternative routes, shown in FIG. 7,

FIG. 9 shows a flow chart indicating actions of an on-path node receiving a PSA, and determining if it is a Selector candidate or a Chooser,

FIG. 10 shows a flow chart with more details of the actions of nodes on the path downstream of a Selector candidate node, receiving an SReqM message from a Selector candidate,

FIG. 11 shows the actions of the Selector candidate when it receives an SAckM message from the Chooser that the Selector candidate should become the Selector to implement a given one of the paths being restored, and

FIG. 12 shows an implementation of the messages used in this invention in the OSI protocol layers.

### DETAILED DESCRIPTION OF INVENTION

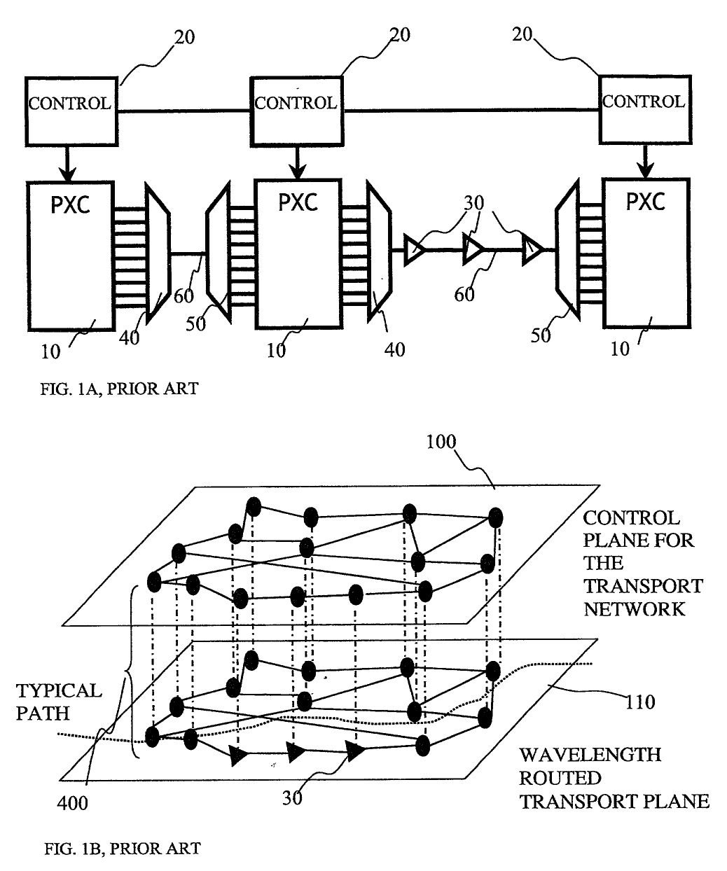

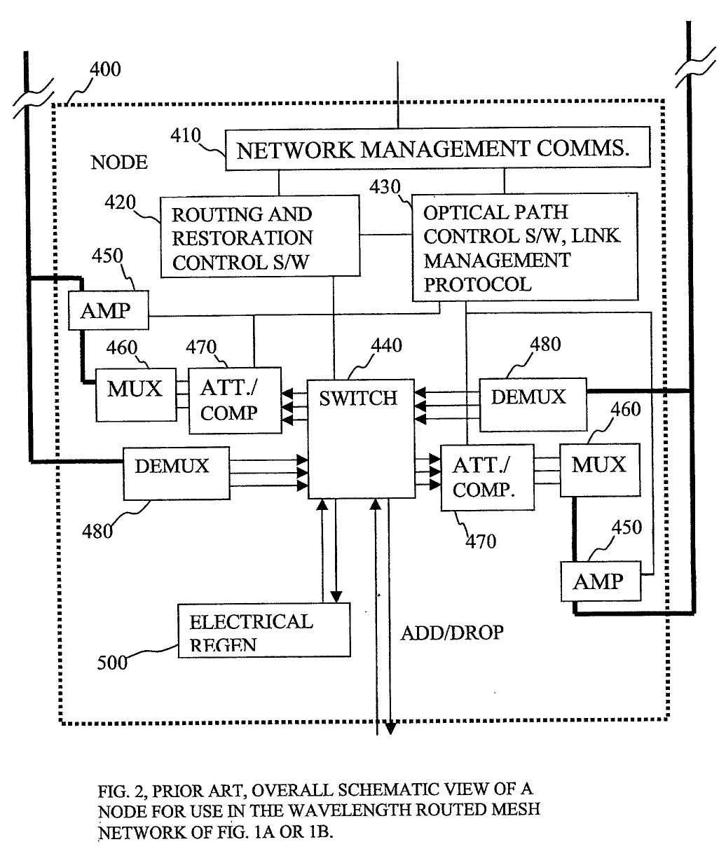

By way of introduction to the examples of how to implement the above mentioned features, first of all, a typical network will be described briefly. FIG. 1 shows in schematic form, a type of network, in which embodiments of the present invention may be applied. Part of such a network is shown in FIG. 1A.

### FIGS. 1A, 1B, Wavelength Routed Optical Network.

FIG. 1A shows some of the principal elements in schematic form of a conventional wavelength routed optical network. Photonic cross connects (PXC) 10 are located at many or each of the nodes of the network. Three are shown, though in practice there may be a mesh of tens or hundreds of nodes inter-connected in a mesh, depending on required traffic characteristics. The cross-connects may be implemented using electronic switching, or optical switching, or a mixture. Wavelengths, or bands of wavelengths, or groups of wavelengths may be switched between different links in the network to enable them to reach their desired destination node. A control channel 20 is provided for control signals to be passed between nodes, to control the routing of each wavelength or group of wavelengths. The control channel 20 can be either in-band or out-of-band of the links 60. The control channel may be diversely routed or commonly routed with corresponding transport links. If commonly routed, it may share the same fiber, or take a different fiber. Links 60 between nodes may be long enough to require amplification by optical amplifiers 30.

Typically, tens or hundreds of wavelengths are wavelength division multiplexed on to each fibre for transmission between nodes. There may be tens or hundreds of fibres in each link between nodes. Wavelength division multiplexers 40 are provided for combining many wavelengths on to a single fibre. Correspondingly, wavelength division demultiplexers 50 are provided for physical separation of the wavelengths to enable switching by the PXC. Various technologies can be used for wavelength multiplexing and demultiplexing, including arrayed waveguide devices using radiative stars, devices based on bragg gratings, or based on other refractive of diffractive effects, or even photonic bandgap effects for example.

The PXC may be implemented in many different ways, including mirror based MEMS type technology, liquid crystal technology, or others known to persons skilled in the art. The control channel or control plane is needed for dynamic provisioning of light paths in such a wavelength routed optical networks. Provisioning means setting up new routes on demand, and maintaining them, for example by altering the route if necessary because of congestion or a faulty link or node for example.

The control plane may take any configuration. There may be centralised control, in which case the control plane may form a star configuration radiating out to each node from the central controller. It is often more practical, in terms of speed, reliability and adaptability, to use a flat, peer to peer type arrangement of distributed control, with each node communicating with neighbouring nodes to pass on routing commands.

FIG. 1B shows an example of such a control plane 100. It has been illustrated separately from the transport plane 110. In practice, there may or may not be separation at each physical node, and there may or may not be physical separation between the links of the control plane and the links of the transport plane. As illustrated in FIG. 1B, the links in the control plane mirror the links in the transport plane. This is not essential, but is preferable. In any case, the control plane links may be routed along the same fibre as the corresponding transport plane link, or may be diversely routed.

An example proposed for the control plane is to use an IP (Internet Protocol) network for passing messages between nodes. IP packets may be formed in to Ethernet frames for transmission over individual links. It has also been proposed to use MPLS (Multi Protocol Label Switching) to enable frames to be routed properly without having to decode the entire IP address field at each router.

Furthermore, it has been proposed to use a new link management protocol (LMP) for link verification and fault isolation. LMP has been described in drafts submitted and publicly available through the IETF (Internet Engineering Task Force). Another alternative is FLIP (Fast Liveness Protocol).

### FIG. 2, Schematic View of a Node for Use in the Network of FIG. 1A or 1B.

FIG. 2 shows a possible configuration of a node for use in the wavelength routed mesh network of FIG. 1A or 1B.

Some details of the internal arrangement of one of the nodes are shown in schematic form. The other nodes can be similar, or, otherwise. The node includes optical amplifiers 450, network management communications functions 410, routing control software 420, and optical path control software 430. These can employ conventional hardware, designed to suit the particular application, following well established principles.

At the heart of the node is an optical switch 440, for routing individual channels carried by individual optical wavelengths or groups of wavelengths. As shown, there is a bi-directional optical link between each of the nodes, and at each node, a number of channels can be added or dropped. Such add/drop lines can be coupled to local users, or to local networks, or they can be coupled to other high capacity optical networks.

The switch can optionally include the capability of changing the wavelength of a channel. To couple the optical links to the switch, there are wavelength demultiplexers 480 for taking incoming wavelength division multiplexed signals, and separating them so that individual wavelengths, or groups of wavelengths can be switched on to different physical paths by the switch 440. A corresponding wavelength division multiplexer 460 is provided for coupling out going signals from the switch on to the optical links.

Before the signals are multiplexed, optionally, an attenuation/compensation block 470 can be provided. This block may alternatively, or additionally, be placed at inputs to the switch. The purpose of this block is to control the optical characteristics of each of the wavelengths, to enable better optical performance to be achieved. Typically, this can involve adjusting the power levels by attenuation, to compensate for differences in gain between the channels by the optical amplifiers. It can involve dispersion compensation, and other types of compensation for degradations that vary with wavelength.

As the optical gain provided by the optical amplifiers, and the attenuation and compensation provided by block 470 may need to be optimised on a network wide basis, the optical path control software is shown coupled to other nodes, or a centralised network management system (not shown) via the network management communications function 410. Also, the optical path control software is shown coupled to the routing control software, to enable the optical characteristics to be optimised depending on the source and destination of the wavelengths being transmitted.

Various types of optical switch are known, including as movable mirror based switches, though others including liquid crystal devices or interferometers for example, may prove to be preferable for particular applications. The choice may depend if they can be made more compact or more economically, or operated at higher speeds, or with lower loss if there are large numbers of connections for example.

Electrical regeneration capability 500 is shown coupled to the switch. The switch may selectively route optical signals to this part, to enable longer reach, or improved signal quality. It can be implemented using receivers and lasers or tunable lasers if wavelength conversion is also implemented, following well established principles.

At various locations along the optical paths within the node, optical signal quality can be monitored using an optical tap. Typically this is carried out within the optical amplifier subassemblies, 450, to measure the optical power output, or input power, or both. The result can be fed to the optical path control software.

### Routing Using MPLS

Conventionally, the routing control would be carried out using the protocols mentioned above shown as functions 420 and 410, running on conventional microprocessor or DSP, or ASIC based hardware. It could make use of current proposals to extend multiprotocol label switching (MPLS), a well known collection of distributed control protocols used to set up paths in IP networks, to manage mesh-based optical network connections. The MPLS application for wavelength provisioning signalling is called MPλS. A generalized version applicable to control and provisioning of many different network layers, called G-MPLS, has also recently been proposed, published as an IETF Internet Draft.

MPLS was primarily developed for Internet Protocol (IP) networks. One principal use of MPLS is to implement Label Switched Paths (LSPs). Packets associated with a given LSP are identified by their labels which, for most networks, are carried within prepended fixed length headers. Applications of MPLS include traffic engineering, Virtual Private Networks (VPNs), Quality of Service (QoS) for different types of services, and IP layer restoration.

Two different signaling protocols, Resource ReSerVation Protocol (RSVP) and Label Distribution Protocol (LDP) are currently used to establish an LSP. There are two ways to implement an LSP within an MPLS network, hop by hop using LDP and Explicitly Routed LSP (ER-LSP). Both RSVP Traffic Engineering Extension (RSVP-TE) and Constrained-Based LDP represent the latter approach. RSVP messages are transmitted directly on top of the IP protocol, as opposed to those of CR-LDP which are transmitted over TCP (Transmission Control Protocol).

MPLS supports nearly all existing internet protocols. The labels could be not only assigned in an IP network, but also set as VP/VC (Virtual Path/Virtual Circuit) in ATM, DLCI (Data Link Connection Identifier) in Frame Relay, and wavelength (Lambda) or optical channel in D-WDM as well. In recent proposals, MPλS is used to manage optical network connections. MPλS defines the control planes for Optical Cross-Connects (OXCs). The similarities of Label Switching Router (LSR) and OXC enable it to exploit recent advances in MPLS control plane technology and also leverage accumulated operational experience with IP distributed routing control.

### The Label Switched Wavelength

The wavelengths in a mesh network are considered as unidirectional paths provisioned through the GMPLS/CR-LDP. Each of the wavelengths will be represented through a Constraint-based Routed Label Switched Path (CR-LSP) and therefore have an Label Switched Path Identifier (LSPID). LSPID is a unique identifier of a CR-LSP within an MPLS network. Among other values the LSPID has the information in the form of:

[Ingress LSR ID]:[ID unique to Ingress LSR].

Normally the Ingress LSR ID is the IP address of the ingress LSR. For any link that carries multiple wavelengths, there will be one LSPID for each of the wavelength, in this document, the nodes through which the wavelength travels, are termed ‘on-path’ nodes. Each ‘on-path’ node will maintain a database of the LSPs going through. In case of a failure, the affected LSPs will be identified.

### Failure Detection

For a dynamic rather than a pre-planned restoration process, usually the restoration time consists of three parts: path choosing time, path setting time and cross-connect time. Since the cross-connect time is a physically fixed time (about 10 ms), most prior restoration schemes are focused on reducing the first two parts of time.

Failure detection is one of the crucial functions for failure recovery. Generally, rerouting the restored path can occur either at the source of a flow (ingress node) or around the failure. In the first case, fault detection is hampered by the fact that detecting an LSP failure at the ingress node can take a long time, since the ingress node is responsible for setting up, tearing down, and maintaining the LSP via explicit routing. However it has the advantage of higher resource utilization. In order to get a faster restoration, restoration around the failure is preferred, though the invention encompasses both. In a traditional SONET/SDH optical network, failure detection is triggered by an LOS (Loss Of Signal), detected in the electrical domain. In an all optical network there is no electrical signal. The failure detection can be performed by other means for example using LMP or FLIP protocols mentioned above.

In the optical transport network, the OXCs with wavelength conversion capability enable MPλS to use wavelength or optical channel as the label. The importance of wavelength conversion in optical networks is well known, and preferably all the OXCs have wavelength conversion capability.

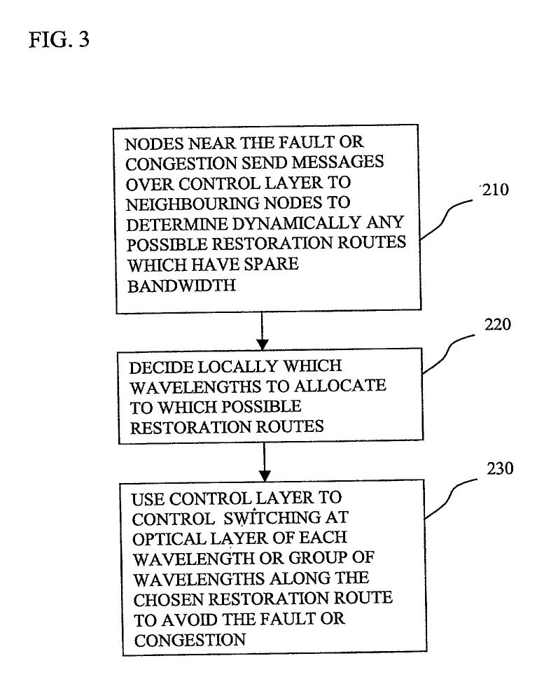

MPLS does not specify a restoration scheme. FIG. 3 shows a new scheme for use by the restoration function 420 of FIG. 2, according to a first embodiment of the invention.

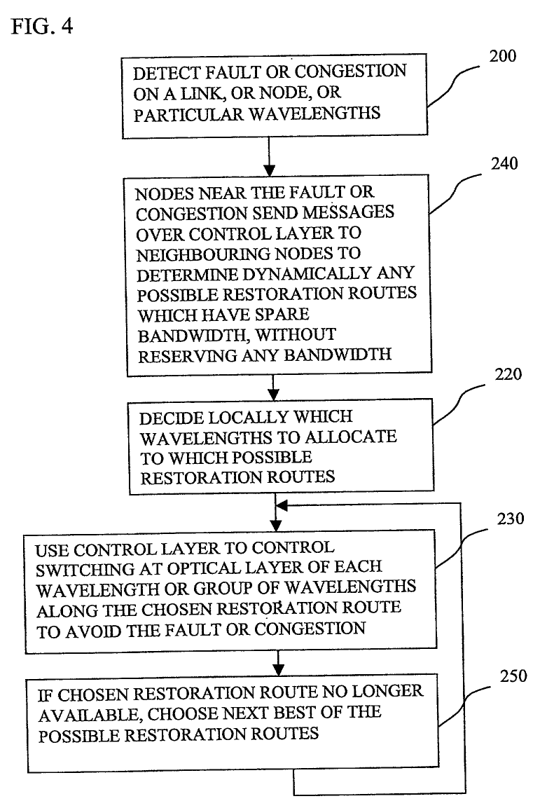

### FIGS. 3, 4, Fast Restoration Scheme Summary

The restoration scheme described below has three phases, a broadcast phase, a selection phase and a path setting phase. Each node or PXC has the same state machine algorithm to execute the phases to find a restoration route in a distributed fashion. In the path setting phase, either RSVP-TE or CR-LDP is preferred to deploy the restored LSP, though other protocols may be used. The embodiment described below uses CR-LDP.

Although the broadcast or search phase is distributed, the selection is locally centralised at the Chooser. In case of a failure, the node downstream of the failure becomes the Sender, and the node upstream of the failure becomes the Chooser. An ‘on-path’ node which is upstream of the Chooser can become a Selector candidate to switch the wavelength and to prevent the formation of a ‘hair-pin’ where the restoration path doubles back on itself. A more detailed description of the function of a Selector is set out below. The Chooser plays a central role in the Restoration Algorithm. After receiving the search messages, (called Path Statement Advertisements, PSAs) and Selector Request Messages (SReqM) the Chooser makes a table of the collected information about possible restoration routes. This Table at the Chooser is one of the Restoration Algorithm's key features. This Table will store the relevant optical path information obtained from the PSA and the SreqM messages, i.e. the path vector and the spare wavelength vector of the PSA's path. Based on the information in the table the Chooser will be able to choose the best route, and either starts the restoration process through the CR-LDP protocol or sends a SAckM with the proposed restoration route and wavelength to the Selector candidate.

The Chooser then initiates the CR-LDP protocol to set up the chosen restoration path, or causes a Selector candidate, upstream on the path, to do so.

FIG. 3 shows some of the principal steps in a restoration process, which could be implemented by software running on conventional hardware, represented by box 420 in FIG. 2. Three steps are shown. At 210, nodes nearer the fault or congestion send messages over the control layer to neighbouring nodes to determine dynamically any possible restoration routes which have spare bandwidth. This may be termed the search step. At 220, it is determined which wavelengths to allocate to which of the possible restoration routes determined in step 210. At step 230 these decisions are implemented. The control layer is used to control switching at the transport or photonic layer of each wavelength or group of wavelengths along the chosen restoration route.

There are various ways of implementing each of these three basic steps shown in FIG. 3. It is possible to reserve some of the redundant capacity available for restoration, using the search messages sent in step 210. Alternatively, as shown in FIG. 4, the search step can be carried out reserving any bandwidth. The embodiment of FIG. 4 starts with step 200, of detecting the fault or congestion on the link or node, or particular wavelengths. At step 240, nodes near the fault or congestion send messages over the control layer to neighbouring nodes to determine dynamically any possible restoration routes which have spare bandwidth. The spare bandwidth is not reserved at this stage. At step 220 it is determined locally which wavelengths to allocate to which possible restoration routes.

At step 230 the restoration route chosen for each wavelength or band of wavelengths is implemented. This involves using the control layer to control switching at the photonic layer. Of course the three steps of searching, allocating and implementing can be carried out for each wavelength or band of wavelengths sequentially, or the process can be carried out in parallel for may wavelengths or bands of wavelength.

At step 250, if the chosen restoration route is no longer available, the next best restoration route is allocated. This is a consequence of not reserving any bandwidth at the search step 240. It is possible that part of the desired restoration route will now be unavailable if, for example, it has been taken up by a new connection, or a new restoration route arising from a different fault in the network. There is an advantage in not reserving bandwidth during the search process. It avoids the problem of the first search message reserving bandwidth and making it unavailable to later search instances which could have turned out to provide better, more efficient restoration paths.

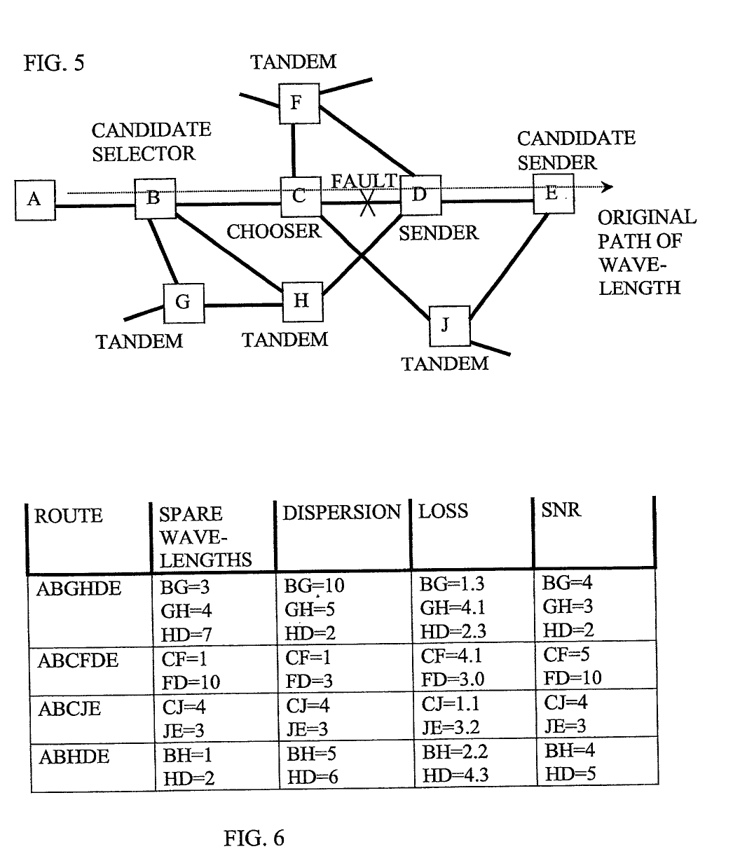

### FIG. 5, Mesh Network Showing Sender, Chooser, Tandem Node and Selector Candidate.

FIG. 5 shows a portion of a mesh network, showing nodes A, B, C, D, E, F, G, H and J, with links AB, BC, CF, FD, DE, BG, BH, GH, DH, CJ, and EJ. Each of the links may have many wavelengths. There may be many paths through the network occupied at any time. One path is shown, through nodes A, B, C, D, and E. A fault is shown on link CD. There are many possible ways of dynamically determining possible restoration routes. Many of these involve an exchange of messages between nodes adjacent to the fault. In FIG. 5, the nodes around the fault are labelled to indicate the role they play in the restoration process. In practice each node should be able to play any role, and should be able to determine which role it should play, as will be explained below.

The node downstream of the fault determines it is a Sender node. The node upstream of the fault determines it is a Chooser node. Other nodes not on the original path may be tandem nodes. Other nodes on the original path upstream of the Chooser may be Selector candidate nodes, or downstream of the sender, other nodes may be candidate sender nodes. Therefore in FIG. 5, D is the Sender, C is the Chooser, and B is a Selector candidate and E is a candidate sender. Nodes F, G, H and J are tandem nodes, as they lie on possible restoration routes around the fault.

The functions of each of these nodes in the restoration process will be described in more detail below. Of course, where there are multiple faults, a node may need to perform different roles simultaneously in respect of each of the faults.

### FIG. 6, Table of Capacities and Optical Characteristics.

FIG. 6 shows a table of characteristics for each of the possible restoration routes around the fault shown in FIG. 5. In the left hand column of FIG. 6 the route of the restoration path is shown. There are four possible paths, ABGHDE, ABCFDE, ABCJE, ABHDE. The second column indicates the number of spare wavelengths available at any given time, on each of the links of the given route. The third, fourth and fifth columns show optical characteristics for each of the links. This information about the possible restoration routes will be collected by the messages sent during the search phase. It will be gathered at one of the nodes, typically the Chooser node. The information on spare wavelengths may vary dynamically. The optical characteristics may vary slightly with time or vary as components or parts of the network are upgraded. It may be possible to measure these characteristics dynamically at each node. These are just examples of typical optical characteristics. Other characteristics may be used. There numerous possible causes of optical degradation, including cross talk, non-linearities, PMD (Polarisation Mode Dispersion) and so on.

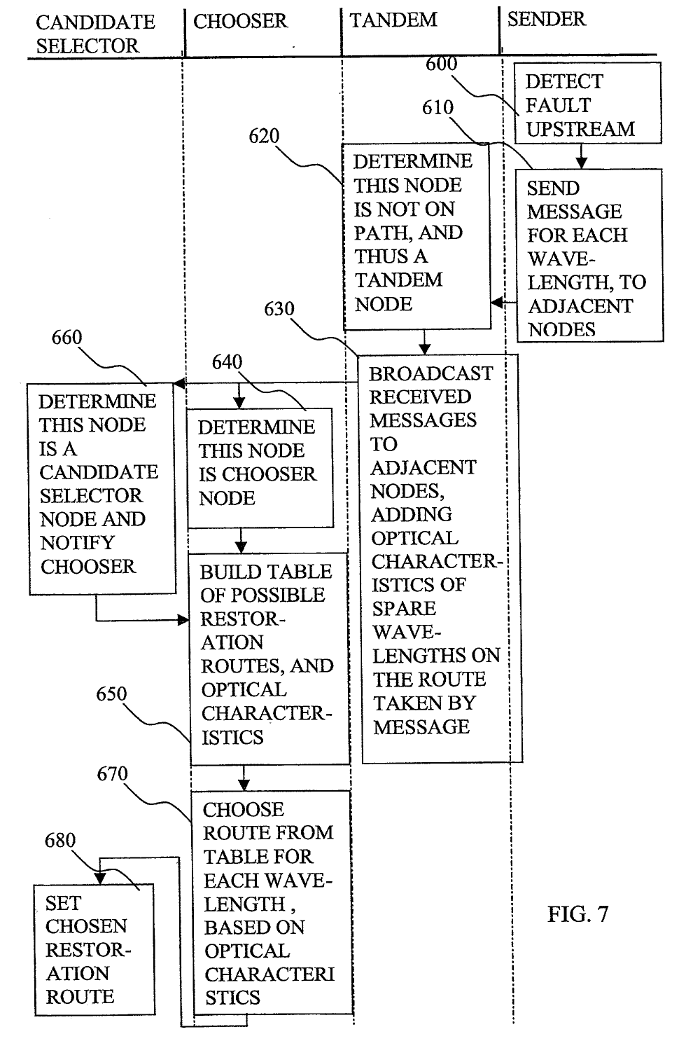

### FIG. 7, Sequence Chart Showing Some of the Functions of Each of the Types of Nodes Shown in FIG. 5

FIG. 7 shows a sequence chart including some of the principal actions of the Sender, the tandem node, the Chooser node and the Selector candidate node, when carrying out the restoration process. At Step 600, the node downstream of the fault detects the fault. This may involve detecting loss of the optical signal, or detecting degradation of the optical signal. Alternatively, the restoration process may be triggered by detecting congestion, in the form of too many requests for connections over a particular link. Other nodes downstream such as node E in FIG. 5 may also detect a loss of signal. Each node in the path may exchange messages to determine which is the node closest to the fault. This node becomes the Sender node.

At step 610 the Sender starts the search phase by sending messages to adjacent nodes searching for possible restoration paths. In theory, it is not essential that the Sender start this, other nodes could do so. At step 620, an adjacent node receives such a message. It determines whether it is on the original path. If not, it determines that it is tandem node. It goes on at step 630 to broadcast the received search message to nodes adjacent to it. It adds optical characteristics of the spare wavelengths on the route. This enables the Chooser to build up a table of the possible restoration routes and the optical characteristics. At 640, a node such as node C determines it is on the path and therefore may be a Chooser node, if it is the node closest to the fault and upstream of the fault. At step 650 the Chooser node builds the table of possible restoration routes and optical characteristics of those routes, as shown in FIG. 6 for example.

At step 660, if the search message is received by a node on the path, but not adjacent to the fault, the node determines it is a Selector candidate. It notifies the Chooser downstream, and the Chooser adds another possible restoration route to its table. At step 670, the Chooser will choose a restoration route for each wavelength or a group of wavelengths, based on the optical characteristics of the routes. If the chosen route goes via a Selector candidate, the Chooser sends a message to the Selector candidate to cause the Selector candidate to set up the route for that particular wavelength or group of wavelengths, as shown at step 680.

The use of a Selector candidate and steps 660 and 680 in particular are optional, since the Chooser could dispense with the Selector candidate. In this case the Chooser could wait for PSAs to arrive, and implement the chosen route itself. The advantage of the Selector candidate is that it enables the restoration route to bypass the Chooser, if this gives a better route. Other ways of achieving this advantage can be conceived.

Although not illustrated in FIG. 7, the candidate sender, node E, can be used to achieve a similar advantage. It can enable the sender to be bypassed. This may be achieved by sending PSA messages from the candidate sender, or more simply by adjusting the PSAs received from the actual sender, so that when forwarded, they appear to have been sent from the candidate sender.

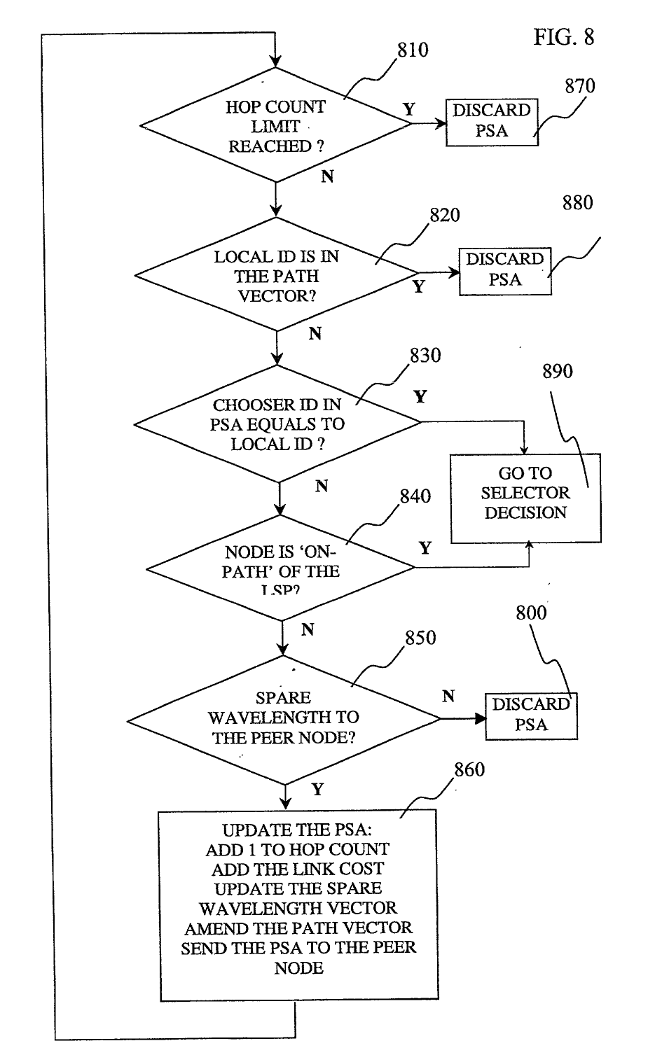

Further details of a preferred embodiment will now be described with reference to FIGS. 8-11.

### FIG. 8. Limited Flooding, Broadcasting of PSA Messages to Search for Restoration Paths

As discussed above, the search phase involves a flood of PSA messages initiated by the sender sending them to all its adjacent nodes. The flood is propagated by having each node which receives a PSA, broadcasting it on to all nodes adjacent to it. On receiving the PSA a node will refresh the field values in the PSA before broadcasting it on further. Limiting the extent of this flood to avoid the generation of redundant PSAs helps make the restoration faster and more efficient. Three ways of limiting the flood are described. First, a loop condition is avoided by using Path Vector PV. Furthermore, a PSA whose hop count value exceeds a pre-determined limit is discarded. Thirdly, when the PSA reaches the on-path node, the flooding process will stop. An example of PSA flooding is depicted in FIG. 8.

When the downstream Sender node detects a network failure, it will send out the PSAs to all its neighbors except its downstream neighbor (the upstream neighbor is separated from the downstream neighbor by the failure). FIG. 8 shows the flow diagram of the events when an adjacent node receives a PSA. At step 810, the node will first examine whether the Hop Count has reached a provisionable limit, which is typically set to 5 by default. At step 870, it will discard PSAs that have reached the maximum Hop Count to limit network flooding. The next check, step 820, is to see whether the PSA has passed this node before by examining the Path Vector. If the local node ID is in the Path Vector, this PSA is being looped back to the node and will be discarded as well, at step 880. Two pieces of information in the PSA will be looked at in the next steps. First, step 830, whether the Chooser ID in the PSA equals the node's ID, is checked. If yes, the PSA has reached the Chooser, and appropriate action 890 is taken. Otherwise, at step 840, the node will then examine whether it is an ‘on-path’ node of the LSP presented by the PSA. If the node is on-path then at step 890 this node becomes a Selector candidate, and will send a SReqM to its downstream LSP neighbor.

If the node is neither the Chooser nor an on-path node, the node is a tandem node. At step 850, the tandem node will see whether it has a spare wavelength available on the ports to its neighbors, if it has no spare wavelength it will discard the PSA at step 800, otherwise the information carried by the PSA will be updated: Hop Count, Link cost, Path Vector and Spare Wavelength Vector. The updated PSA will then be sent to adjacent nodes.

Local Data held by each node
For the purpose of the restoration process, each node keeps the following
Local Data:

| | |
|---|---|
| Adjacencies: | the port the neighbouring nodes are connected |
| | to; |
| Label Mapping Table: | which wavelength (label) is mapped to which |
| | port; |
| LSPID Database: | which LSP pass through the nodes and |
| | through which port; |
| Wavelength: | the attributes of the wavelengths which are |
| | available at each port; |

The information carried by the PSA

| | |
|---|---|
| Sender ID: | normally the IP address of the Sender; |
| Chooser ID: | normally the IP address of the Chooser; |
| LSPID: | in the form of (Ingress LSR ID):(ID unique to |
| | Ingress LSR); |
| Hop count: | this is a provisionable value indicating the |
| | number of the nodes the PSA has travelled, |
| | will be incremented by each node; |
| Cumulative Path Cost: | the sum of the cost metrics the PSA has |
| | travelled, for photonic network the metrics |
| | may include other physical analogue |
| | impairment than distance; |
| Path Vector: | The path the PSA travelled through; |
| Spare Wavelength | This field records the available wavelengths |
| Vector: | on each link as the PSA is propagated from |
| | one node to the next. This field will include the |
| | number of available wavelengths, their port |
| | numbers, and their optical characteristics. For |
| | most optical characteristics, there is little |
| | variation with wavelength, and so no need to |
| | record these separately for each wavelength. |

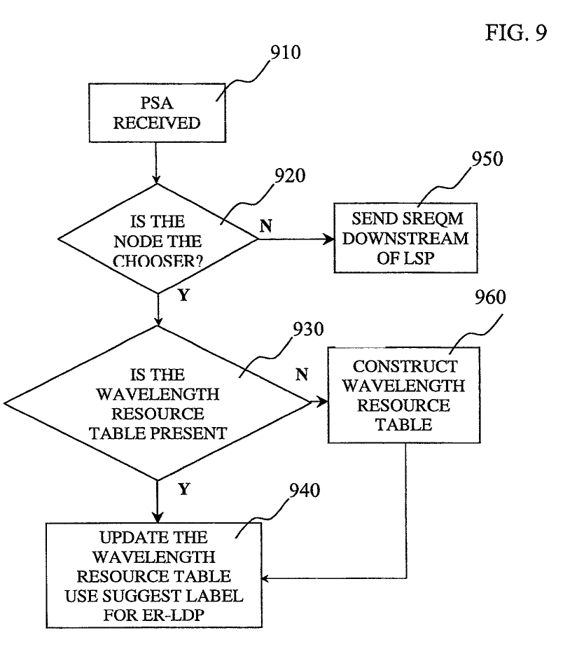

### FIG. 9, Actions of an On-Path Node Receiving a PSA

When the broadcast PSAs reach on-path nodes, as shown in FIG. 9, at step 910, if they are upstream of the Chooser, these on-path nodes determine at step 920 they are Selector candidates. Then, rather than continuing the broadcasting, it is preferred to have a procedure for sending the information in the PSAs directly along the original path, to the Chooser. This involves sending an SReqM message at step 950.

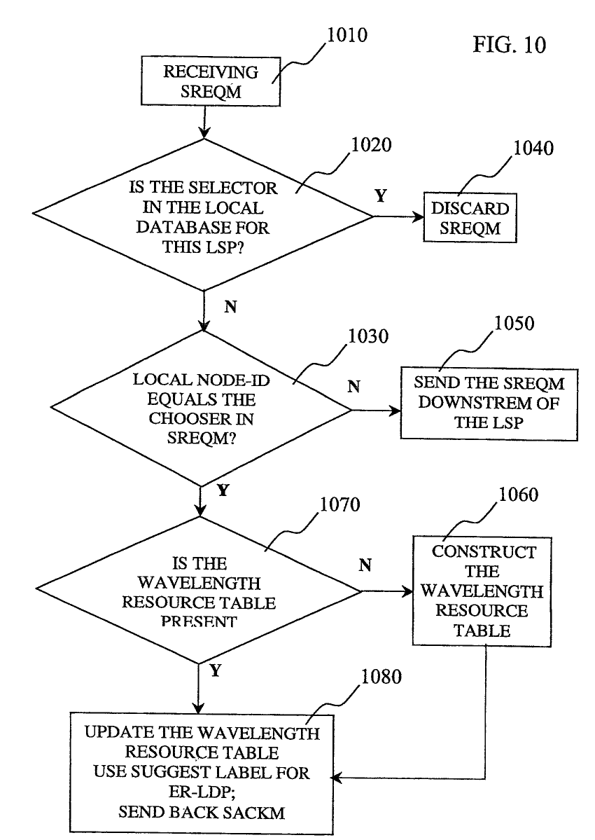

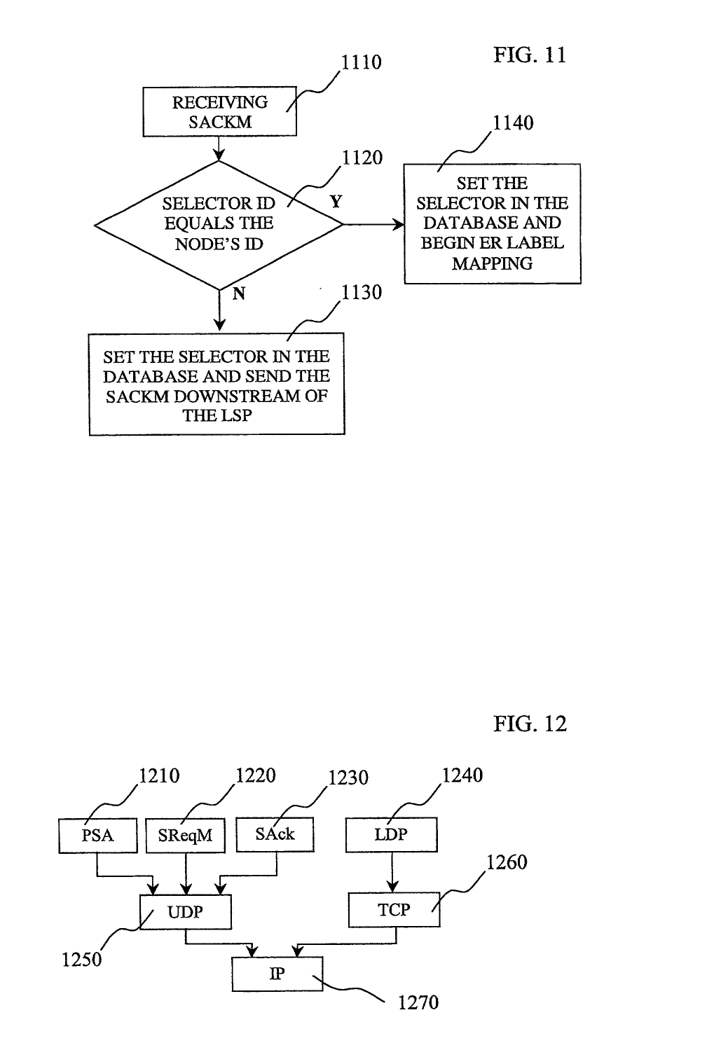

If the node is the Chooser, it starts constructing the wavelength resource table, if it has not been started before for a given fault, at steps 930, 940, 960. The Chooser will delegate setting up the chosen path to the Selector candidate if there is one, using the SackM message as described below with reference to FIGS. 10 and 11.

### FIG. 10, Actions of Selector Candidate Nodes, and Nodes on Path, to Complete the Table for the Respective Fault

Any ‘on-path’ node receiving a PSA will become a candidate Selector for the LSP represented by that PSA. The candidate Selector will then notify the Chooser of the possible restoration route, and where it joins the original path, by sending a Selector Request Message (SReqM) downstream towards the Chooser. As there may be several such messages from different Selector candidates, based on the same LSPID, the Selector candidate must await an acknowledgement before acting as the Selector. As shown in FIG. 10, once the neighboring node receives the SReqM, shown by step 1010, the node will check the database at step 1020 to determine whether this SReqM with its LSPID to be restored has already been restored. In other words whether the acknowledgment message SAckM for this LSPID has already passed this node. If yes, then this SReqM will be discarded, shown by step 1040. Otherwise the node will check at step 1030 whether the local node ID equals the Chooser ID in the SReqM. If not, the SReqM is further sent downstream towards the Chooser, shown by step 1050.

If the node ID equals the Chooser ID in the SReqM, this indicates the SReqM has arrived at the Chooser for the particular LSP to be restored. Based on the information carried in the SReqM (e.g. Cumulative Path Cost, Path Vector, Spare Wavelength Vector). The Chooser will start to construct a Wavelength Resource Table (WRT) if there is none existing, as shown by steps 1070, 1060. After receiving the PSA and SReqM the information in the Path Vector and Spare Wavelength Vector will be added to the table. A Resource Table such as that shown in FIG. 6 will be built including at least the numbers of available wavelengths and their optical characteristics. The Resource Table can be extended to include many analog impairments at the physical layer. The Resource Table will be updated as the wavelengths being assigned from Chooser or through the SAckM through the Selector.

### Choosing the Restoration Route

The Chooser maintains the Wavelength Resource Table (WRT) to solve the link contention problem. The Chooser will then have an overview of the wavelengths that need to be restored and the available resources in terms of possible restoration routes, and their optical characteristics, according to the routes travelled by PSAs. The Chooser is responsible for coordinating the restoration of the wavelengths between the Sender and Chooser. According to the Resource Table a most suitable wavelength will be chosen and sent to via the Suggested Label in the Selector Acknowledgement Message (SAckM), shown by step 1080. The choice will be made according to the optical characteristics, because optical degradations may make some routes suitable for some signals and not for others. For example, a route which is shortest in terms of hop count, the traditional assessment measure, could have worse optical characteristics, or require more wavelength conversions, than another route with a higher hop count. Also, the choice may be made dependent on the optical characteristics of the original path being restored. For example, if one wavelength has a long original path which approaches the limits for optical reach set by optical launch power and signal to noise ratio at the detector, then it should be restored along a route with minimum optical degradations. Or, the restoration route could be chosen to include an optical or electrical regeneration step. On the other hand, a shorter original path having more optical power margin available, could tolerate being restored along a restoration route having worse optical characteristics.

The SReqM message
The SReqM message has the following information:

| | |
|---|---|
| Chooser ID: | normally the IP address of the Chooser; |
| LSPID: | in the form of (Ingress LSR ID):(ID unique |
| | to Ingress LSR); Selector ID: normally the IP |
| | address of the Selector candidate; |
| Cumulative Path Cost: | same as in PSA; |
| Path Vector: | same as in PSA; |
| Spare Wavelength Vector: | same as in PSA |

### FIG. 11, Actions of Nodes on Path, Receiving an SAckMfrom the Chooser

The Selector concept is introduced here to avoid possible “hair pinning” of the restored wavelengths. In other words, it can remove the wasteful “doubling back” of the path between the Selector and the Chooser. The Chooser indicates it has chosen one particular candidate Sender to implement its possible restoration route bypassing the Chooser, by sending a SackM message. When the SAckM travels back towards the Selector, it may be received by a node as shown at step 1110. At step 1120, the node checks if it is the Selector indicated in the SAckM. If not, that node will know it is an en-route tandem node, and will set its internal database to indicate that the LSPID carried in the SAckM is being restored, and the SackM is sent on, as shown in step 1130. This means any further SReqM generated by another PSA reaching a different on-path node, but relating to the same LSP, should not be processed. Once the SAckM reaches the Selector, as shown at step 1140, the Selector will start the wavelength restoration using the information provided (path vector, Suggested Label, LSPID) and the standard CR-LDP protocol.

When a Selector is defined to restore a certain LSP, the wavelength resource it will use is flushed from the WRT. The Chooser also maintains a temporary list which indicates those LSPs already being restored. Triggered by a SAckM transmission, the nodes between the Selector and the Chooser can relinquish the wavelength resource that is used by the failed LSP. By doing this, the “doubling back”, or loop path from the Selector to the Chooser and back to the Selector is eliminated from the path being restored. When a node becomes the Selector, it begins the path setting procedure using CR-LDP or RSVP-TE following the path specified as an explicit route in the Path Vector, in the PSA, or in the SAckM. Since the Chooser is always upstream of the failure, the restoration process using CR-LDP will reserve the resource as the restoration path setting message travels along the explicit route, this will avoid any possible contention for resource

The data carried by SAckM:

| | |
|---|---|
| LSPID: | in the form of (Ingress LSR ID):(ID unique to |
| | Ingress LSR); |
| Chooser ID: | normally the IP address of the Chooser; |
| Selector ID: | normally the IP address of the Selector |
| | candidate; |
| Suggested Label: | Suggested Label to use from Selector to |
| | Sender. |

### FIG. 12

FIG. 12 shows the protocols used for the messages described above. The PSA, SReqM, and SackM messages 1210,1220 and 1230 can be seen as higher than layer 4 and making use of the well known UDP protocol, 1250 at OSI layer 4. This in turn makes use of IP at layer 3, operating on top of a layer 2 protocol such as ATM or Ethernet. An alternative would be to use IP (internet Protocol) 1270 directly, without UDP. Routing the data traffic as opposed to control messages, would use LDP 1240, (a part of MPLS) on top of the well known TCP protocol, 1260.

This means the PSA, SReqM, and SAckMmessages would be encapsulated by a UDP header, in turn encapsulated by an IP header, and around all that, Ethernet overhead.

### Other Remarks

Above there has been described a wavelength division multiplexed optical network has a restoration process to re-route one or more of the wavelengths, by dynamically determining possible restoration routes, and re-routing each wavelength along a chosen one of the possible restoration routes. A distributed dynamic search for restoration routes down to the optical layer, for wavelengths, gives faster and more scalable restoration than reconfiguring routing tables and enables much better utilisation of bandwidth than using predetermined restoration paths.

Although embodiments have been described showing, a Sender—Chooser model, the advantages of the invention are clearly applicable to other types of fast search and choice of route. Although the Sender is downstream and the Chooser upstream in the embodiments described, clearly it is possible to reverse the positions of these, or to have nodes away from the fault take on some or all of these functions. The nodes may be arranged to be aware of the topology and status of adjacent nodes, or even non adjacent nodes. Node failures can be handled as well as link failures, since the Sender and Chooser nodes can still be established either side of the faulty node. Also, faults limited to particular fibers in a link of many fibers, or particular wavelengths within a fiber, for example, can also be handled The role to be played by each node may be determined dynamically by the node itself from the messages it receives, or alternatively may be determined and allocated to that node by another node.

Although as described above, the bandwidth along possible restoration paths is not reserved, it is clearly conceivable to use alternatives, such as reserving the bandwidth, or tagging it so that other restoration processes or requests for new connections, are aware that the tagged bandwidth may be used shortly. This might enable such other restoration processes to take action to try to avoid using the tagged bandwidth, by giving it a higher cost in their resource table, for example.

Although as described above, the search messages follow the possible restoration routes, it is conceivable to have nodes along the route use knowledge of local topology to predict restoration routes, and alert the chooser directly. It is also conceivable to send the optical parameters from each node along a possible restoration route directly to the chooser, rather than along with the search message.

Any references to processes or software, may of course be implemented in software, firmware, ASICs, hardware, and so on, or a mixture of these, as appropriate for the particular application.

Other variations will be apparent to a skilled person which also lie within the scope of the claims.

1. A wavelength division multiplexed optical network having nodes coupled by links, to enable wavelengths to be routed across the network, the nodes being arranged to carry out a restoration process to re-route one or more of the wavelengths, the restoration process having the steps of: sending messages between the nodes to dynamically determine possible restoration routes, and re-routing each wavelength along a chosen one of the possible restoration routes.

2. The network of claim 1, the nodes being arranged to make the choice of restoration route on the basis of optical parameters of the possible restoration routes.

3. The network of claim 2, the nodes being arranged to make the choice of restoration route additionally on the basis of optical parameters of the remainder of the path for the given wavelength.

4. The network of claim 1, the nodes being arranged to make the choice of restoration route on the basis of optical parameters of the remainder of the path for the given wavelength.

5. The network of claim 1, the nodes being arranged to switch traffic from one wavelength to a different wavelength, and the restoration process having the step of choosing a wavelength within that route.

6. The network of claim 1, the nodes being arranged such that a node local to a fault makes the choice of which of the possible restoration paths to choose.

7. The network of claim 1, the nodes being arranged to reserve bandwidth on the restoration routes only after the choice from the possible restoration paths, has been made.

8. The network of claim 1, the nodes being arranged to make a separate search for possible restoration paths, for each wavelength or bands of wavelengths, to be restored.

9. The network of claim 1, the nodes being arranged to send messages along the chosen restoration path to reserve the bandwidth, and if there is insufficient bandwidth, choose another of the possible restoration routes.

10. The network of claim 1, the nodes being arranged to choose a restoration path which rejoins the original path at a node not adjacent to the fault.

11. A node for use in a wavelength division multiplexed optical network having many such nodes coupled by links, to enable wavelengths to be routed across the network, the node being arranged to carry out a restoration process to re-route one or more of the wavelengths, the restoration process having the steps of: sending messages between the nodes to dynamically determine possible restoration routes, and re-routing each wavelength along a chosen one of the possible restoration routes.

12. The node of claim 11, arranged to carry out the steps of sending out search messages, or choosing between possible restoration routes.

13. The node of claim 12, arranged to carry out the steps of a Selector candidate, of identifying a possible restoration path which bypasses the nodes adjacent to a fault, and alerting the node arranged to carry out the choosing step.

14. The node of claim 11, being arranged to make the choice of restoration route on the basis of optical parameters of the possible restoration routes.

15. The node of claim 14, the optical parameters comprising one or more selected from chromatic dispersion, polarisation mode dispersion, optical signal to noise ratio, optical power loss.

16. The node of claim 14, arranged to collect the optical parameters from the nodes along the possible restoration routes, to make the choice of restoration route.

17. The node of claim 16, arranged to use the messages additionally to carry out the collection of the optical parameters.

18. The node of claim 14, being arranged to make the choice of restoration route additionally on the basis of optical parameters of the remainder of the path for the given wavelength.

19. A node for use in a wavelength division multiplexed optical network having many such nodes coupled by links, to enable wavelengths to be routed across the network, the node being arranged to carry out a restoration process to re-route one or more of the wavelengths, the restoration process having the steps of: sending messages between the nodes to dynamically determine possible restoration routes, collecting optical parameters of each possible restoration route, and re-routing each wavelength along one of the possible restoration routes, chosen on the basis of at least the collected optical parameters, and the node being arranged to cooperate with other nodes, and carry out the step of sending out the messages, or the step of making the choice between possible restoration routes.

20. The node of claim 19, being arranged to make the choice of restoration route additionally on the basis of optical parameters of the remainder of the path for the given wavelength.

21. Software for use in a node of a wavelength division multiplexed optical network having many such nodes coupled by links, to enable wavelengths to be routed across the network, the software being arranged to carry out a restoration process to re-route one or more of the wavelengths, the restoration process having the steps of: sending messages between the nodes to dynamically determine possible restoration routes, and re-routing each wavelength along a chosen one of the possible restoration routes.

22. A sequence of data signals on a link of a wavelength division multiplexed optical network having many nodes coupled by such links, to enable wavelengths to be routed across the network, the nodes being arranged to carry out a restoration process to re-route one or more of the wavelengths, the restoration process having the steps of: sending messages between the nodes to dynamically determine possible restoration routes, and re-routing each wavelength along a chosen one of the possible restoration routes, the data signals comprising at least some of the messages, and signals for controlling the re-routing.

23. A method of transmitting data over a wavelength division multiplexed optical network having many nodes coupled by links, to enable wavelengths to be routed across the network, the nodes being arranged to carry out a restoration process to re-route one or more of the wavelengths, the restoration process having the steps of: sending messages between the nodes to dynamically determine possible restoration routes, and re-routing each wavelength along a chosen one of the possible restoration routes, the method having the steps of using the nodes to transmit the data over an original path or, following the restoration process, over a re-routed path.
